(19) United States
(12) Patent Application Publication
(10) Pub. No.: US 2005/0216625 A1
(43) Pub. Date: Sep. 29, 2005

(54) Suppressing production of bus transactions by a virtual-bus interface

(76) Inventors: Zachary Steven Smith, Fort Collins, CO (US); John Warren Maly, Laporte, CO (US); Ryan Clarence Thompson, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/796,728

(22) Filed: Mar. 9, 2004

(51) Int. Cl. G06F 13/00

(52) U.S. Cl. 710/100

(57) ABSTRACT

Systems, methodologies, media, and other embodiments associated with processing point-to-point transactions that are not be processed into bus model transactions by a virtual bus interface configured to convert point-to-point transactions into bus-type transactions are described. One exemplary system embodiment includes a detection logic that facilitates identifying that a point-to-point transaction is a transaction type that is not be processed into a bus model transaction and a tracking logic that facilitates tracking the transaction and related packets through the virtual bus interface and that also facilitates suppressing generating a bus model transaction from a point-to-point transaction.

### BACKGROUND

Computer systems may include computer components that are operably connected together. These computer components may be operably connected by, for example, a bus and/or via a port(s) into point-to-point (P2P) links. Components that are operably connected by a bus typically “listen” to substantially every request placed on the bus, “hear” substantially every response on the bus, and try to communicate over the bus. To facilitate listening, hearing, communicating, and the like, various bus communication techniques, timings, protocols, and so on have evolved. Thus, a transaction like a data read in a bus model system may include producing and monitoring various phases (e.g., arbitration, requests, snooping, data) and sending/receiving various signals during these phases.

Computer components that are operably connected by P2P links operate substantially differently than those connected by a bus. Requests and responses are routed more exclusively between sending and receiving components. Thus, less than all the operably connected computer components may encounter packets associated with a transaction. Packets may be broken up into smaller units known as flits. A transaction like a data read may be performed by sending and receiving packets and/or flits between various source and destination components. The actions taken to send, receive, and/or route packets to perform a P2P transaction may be different than the actions taken to perform a corresponding bus model transaction.

In environments like processor verification and hybrid multi-processing, some components may be connected by a bus like a front-side bus (FSB) and other components may be connected by P2P links. FSB connected components perform certain actions in certain ways. For example, messages intended for one component may be broadcast on the FSB, viewed by all components operably connected to the FSB, and acted on by target components. P2P link connected components perform certain actions in certain other ways. For example, packets may be transmitted between specific components with a crossbar “traffic cop” responsible for directing packets/flits. Since both FSB connections and P2P connections have strengths and weaknesses it is not surprising that some computer systems are FSB connected while others are P2P configured. In some examples, a multiprocessor system or other large system may even include components that are connected using both methods.

Over the years, tools have been developed for designing, analyzing, testing, and so on systems that use FSB. Other tools have been developed for designing, analyzing, testing, and so on systems that use P2P. Since the two systems are fundamentally different, a tool known as a virtual bus interface (VBI) was developed to facilitate correlating and/or comparing results from the different tools.

A VBI facilitates producing bus-type transactions from P2P transactions. This may in turn facilitate communication between systems employing a bus model and systems employing a P2P link model. But, as described above, the conceptual and logical structure of P2P transactions differs fundamentally from that of bus transactions. In some cases there may not be a one-to-one semantic mapping between P2P transactions and bus transactions and in some other cases there may be P2P transactions in which a bus model system is simply not interested.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example bus model configuration of components.

FIG. 2 illustrates an example P2P model configuration of components.

FIG. 3 illustrates an example verification environment in which bus model components and P2P model components may interact through a VBI.

FIG. 4 illustrates an example multiprocessing environment in which bus model linked and P2P model linked components may interact.

FIG. 5 illustrates an example message flow associated with a VBI.

FIG. 6 illustrates an example system for suppressing the production of bus transactions by a VBI.

FIG. 7 illustrates an example method for selectively suppressing the production of bus transactions by a VBI.

FIG. 8 illustrates an example computing environment in which example systems and methods illustrated herein can operate.

FIG. 9 illustrates an example application programming interface (API).

FIG. 10 illustrates an example P6 multiprocessor system with a front-side bus configuration.

### DETAILED DESCRIPTION

Example systems and methods described herein concern improvements to a VBI that produces bus-type transactions from P2P transactions. P2P transactions that are conceptually a null operation (e.g., do not exist) in the bus environment may be tracked in the VBI but the VBI can be controlled to suppress producing meaningless bus transactions from them. Example systems and methods may also facilitate tracking but not producing bus-type transactions for P2P transactions that may affect a core protocol engine (CPE) associated with a P2P linked system but that do not produce a semantic effect in a core associated with the P2P linked system. These transactions may not be translated in, for example, a verification environment where the verification tools are interested in semantic effects in a core being studied but not necessarily in a related CPE. These transactions may be referred to as P2P internal transactions.

A VBI may be used in processor design to facilitate correlating and/or verifying simulation tool actions. A first processor design tool like a bus model register transfer language simulation tool may be available. A second processor design tool like a higher level language P2P link model simulator may also be available. A VBI may facilitate comparing the outputs of the two processor design tools. For example, transactions from the P2P linked model tool can be used as inputs to a VBI that will produce corresponding bus model transactions. Thus, transactions occurring in the P2P link model tool can be compared to transactions occurring in the bus model tool, providing greater confidence in simulation results.

Some transactions in a P2P linked system may have no corresponding transaction in a bus model system. These transactions may be referred to as a “null transaction”. But these null transactions may still occur in the P2P linked system and simply ignoring them in a VBI may lead to undesired results. Therefore, example systems and methods facilitate processing and tracking these types of transactions without producing and presenting a related bus model transaction. Processor design verification applications like those that compare transactions from different simulation tools are thereby simplified since they do not need to account for meaningless records.

In an example VBI transaction tracking logic, completion criteria may be encoded for the null and/or the P2P internal transactions like completion criteria are encoded for transactions that are to be converted. In one example, when a transaction is recognized as a null and/or P2P internal type, the transaction tracking logic in the VBI may “mark” the transaction as a null type and subsequently, based on the marking, not produce a bus model record. For example, when a packet and/or flit type is examined and it is determined that is satisfies a “request” semantic tag in a semantic tag based VBI, then the transaction may be marked. Then, when the marked transaction completes a semantic phase that would normally be reported by the VBI, the actual reporting is not performed. In another example, the transaction tracking logic may update a data structure or store a value in a data store to indicate that a certain transaction like a null transaction or a P2P internal transaction is to be tracked but not converted. Subsequent phases of the transaction may satisfy remaining requirements for a transaction and thus cause the transaction to proceed through the VBI transaction tracking logic. The subsequent tracking facilitates the VBI properly processing later packets related to the null and/or P2P internal transaction.

The following includes definitions of selected terms employed herein. The definitions include various examples and/or forms of components that fall within the scope of a term and that may be used for implementation. The examples are not intended to be limiting. Both singular and plural forms of terms may be within the definitions.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

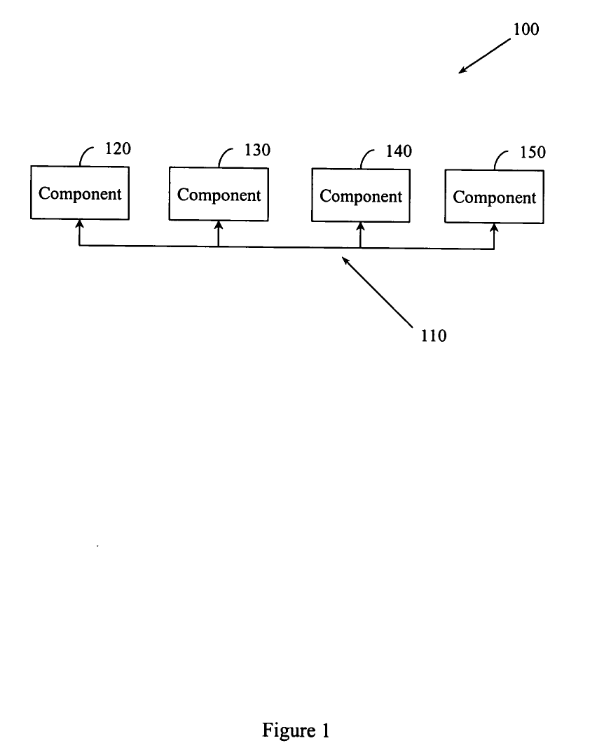

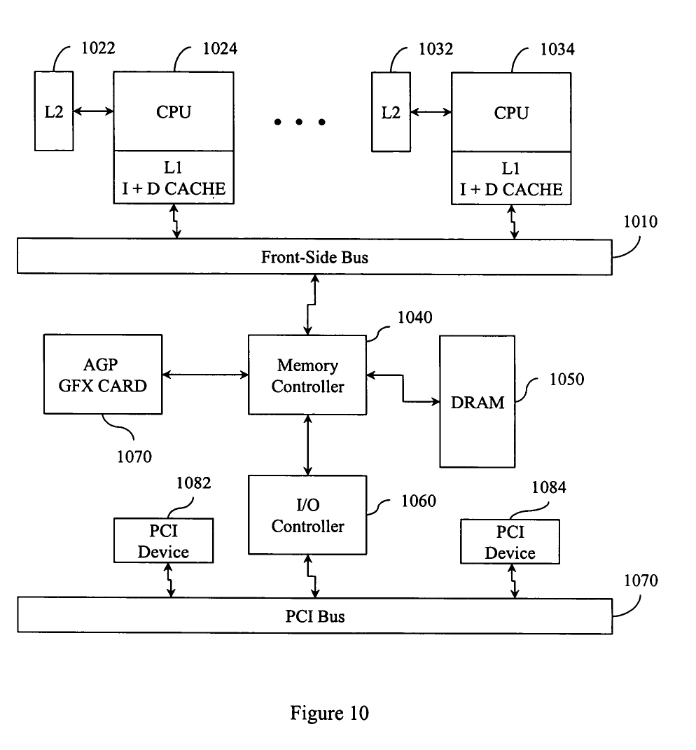

FIG. 1 illustrates an example bus model configuration 100 of components. A bus 110, like a front-side bus, may connect components like component 120, 130, 140, and 150. The components may be, for example, processors in a multiprocessor system, memories, caches, and so on. While four components are illustrated, it is to be appreciated that a greater and/or lesser number of components may be connected. A transaction on bus 110 may include, for example, two fundamental parts like a request part and a response part. The request part may transmit a request to be serviced and the response part may complete or defer the transaction. Thus, a transaction may be thought of as a set of bus activities that relate to a single bus operation like a read or write. A transaction may proceed through multiple phases like an arbitration phase, a request phase, an error phase, a snoop phase, a response phase, a data phase, and so on. A communication between a first component (e.g., 120) and a second component (e.g., 130) will be “heard” by substantially all the components (e.g., 120, 130, 140, 150) operably connected by the bus 110. FIG. 10 illustrates a an example multiprocessing system that uses a front-side bus. CPU 1024 and CPU 1034 may communicate through bus 1010 with a memory controller 1040.

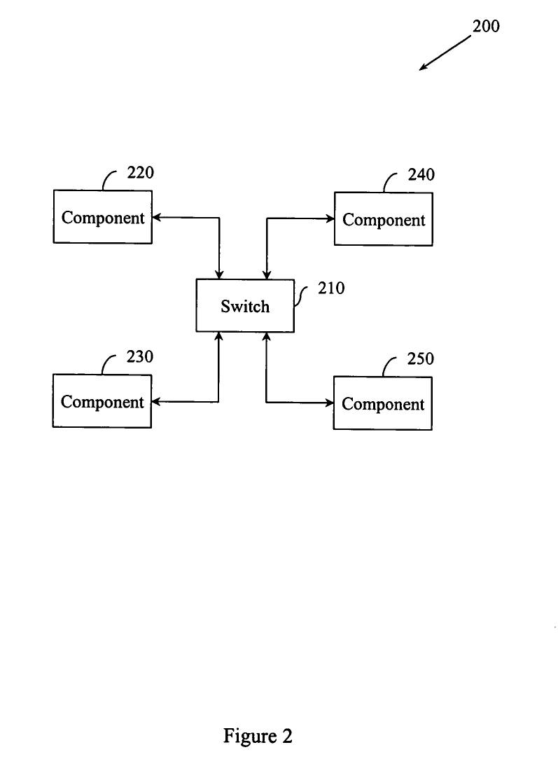

FIG. 2 illustrates an example P2P model configuration 200 of components. A switch 210 like a crossbar switch may connect components like components 220, 230, 240, and 250. Once again, while four components are illustrated, it is to be appreciated that a switch(es) can connect a greater and/or lesser number of components in a P2P linked system. Requests from a first component (e.g., 220) may be routed through the switch 210 to arrive at a second component (e.g., 230). Components other than the first and second component, like components 240 and 250 may not be aware that the communication between the first and second component occurred.

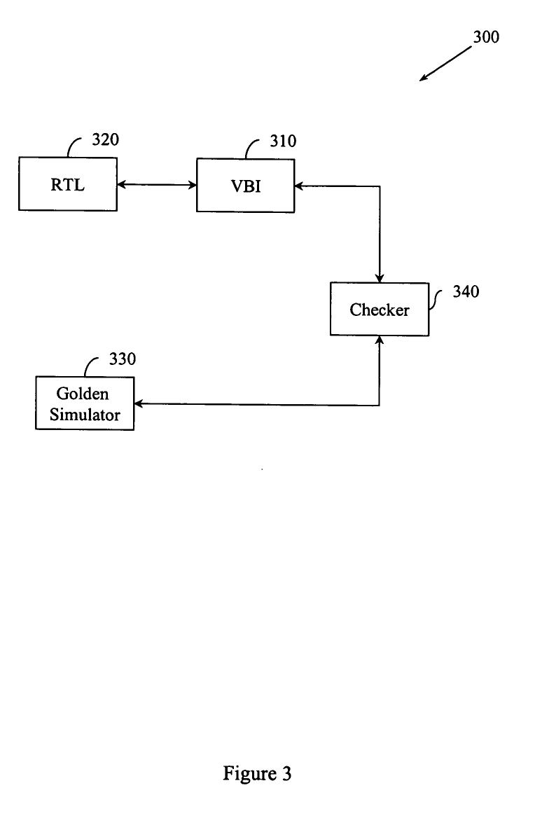

FIG. 3 illustrates a processor design environment 300 in which a VBI 310 is being employed. One step in processor design may be to program the desired architecture for a processor using a register transfer language (RTL) tool 320. The desired architecture may be represented by an RTL specification that describes the behavior of the processor in terms of step-wise register contents. This simulates what the processor does without describing the physical circuit details. Additionally, another tool like a golden simulator 330 may be implemented in, for example, a high level programming language. The golden simulator 330 may also simulate the processor architecture. A golden simulator 330 may be reused through a product family line (e.g., 8086, 80286, 80386). But, as interfaces and connection methods change (e.g., from FSB to P2P), a valuable tool like a golden simulator 330 may be in danger of becoming obsolete. Thus, to extend the useful life of tools like a golden simulator 330, and to facilitate comparing its results with those of other processor design tools like RTL tool 320, the VBI 310 is employed to produce bus model transactions from P2P transactions. A checker 340 may then be employed to compare the results from the design tools.

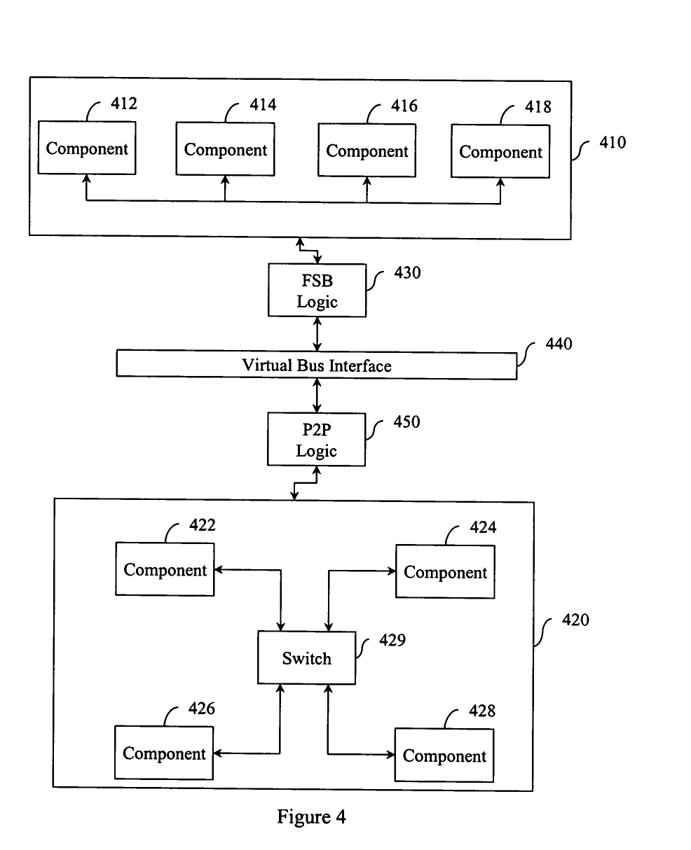

A verification environment is one possible use of a VBI. A hybrid multiprocessor architecture that connects components using both P2P and FSB is another. Thus, FIG. 4 illustrates a system that includes both an FSB subsystem 410 and a P2P subsystem 420. The FSB subsystem 410 may include, for example, components like components 412, 414, 416, and 418 that are connected by a bus. The P2P subsystem 420 may similarly include, for example, components like components 422, 424, 426, and 428 that are connected by a switch 429. While four components are illustrated in each subsystem and while two subsystems are illustrated, it is to be appreciated that a greater and/or lesser number of components and/or subsystems may be employed.

The FSB subsystem 410 may be operably connected to an FSB logic 430 that is in turn operably connected to a VBI 440. Similarly, the P2P subsystem 420 may be operably connected to a P2P logic 450 that is in turn operably connected to the VBI 440. The FSB logic 430 may, for example, provide FSB transactions from the FSB subsystem 410 to the VBI 410 and/or receive FSB transactions from the VBI 440. Similarly, the P2P logic 450 may, for example, provide P2P transactions to the VBI 440 and/or receive P2P transactions from the VBI 440. Thus, a multiprocessing system that includes both bus connected components and P2P link connected components may be another application for a VBI. While a verification environment and a hybrid multiprocessing system are described as applications for a VBI, it is to be appreciated that a VBI may be employed in other applications.

Thus, in one example, a VBI system that is configured to selectively suppress production of bus transactions may include a P2P transaction logic configured to receive a packet associated with a P2P transaction from a P2P linked system. The packet may include an identifier that facilitates determining whether the packet is part of a transaction for which no bus-type transaction is to be produced. Therefore, the VBI system may include a detection logic configured to detect that a packet associated with a P2P transaction identifies the transaction as a transaction for which no bus-type transaction is to be produced. The packet types may indicate that the P2P transaction is, for example, a null-type transaction, a P2P internal transaction, a user-specified transaction, and so on.

The VBI system may also include a bus-type transaction logic configured to selectively produce a bus-type transaction from a P2P transaction when the P2P transaction is a transaction-type for which bus-type transaction production is not suppressed. To facilitate correctly handling other packets associated with a P2P transaction for which no bus-type transaction will be produced, the VBI may include a tracking logic configured to track the P2P transaction and its packets/flits as they are processed by the bus-type transaction logic. Finally, the VBI may include a suppression logic configured to control the bus-type transaction logic facilitate selectively producing bus-type transactions from P2P transactions.

The detection logic and the suppression logic may coordinate their activities concerning suppressing the generation of bus-type transactions using various methods. For example, upon detecting that a P2P transaction is a transaction for which no bus-type transaction is to be produced, the detection logic may store a value that uniquely identifies the transaction in a data structure associated with the VBI system, store a value that uniquely identifies the transaction in a data store associated with the VBI, and/or mark the transaction as a “suppressed” transaction. Then the suppression logic may control the bus-type transaction logic based on the value and/or marking.

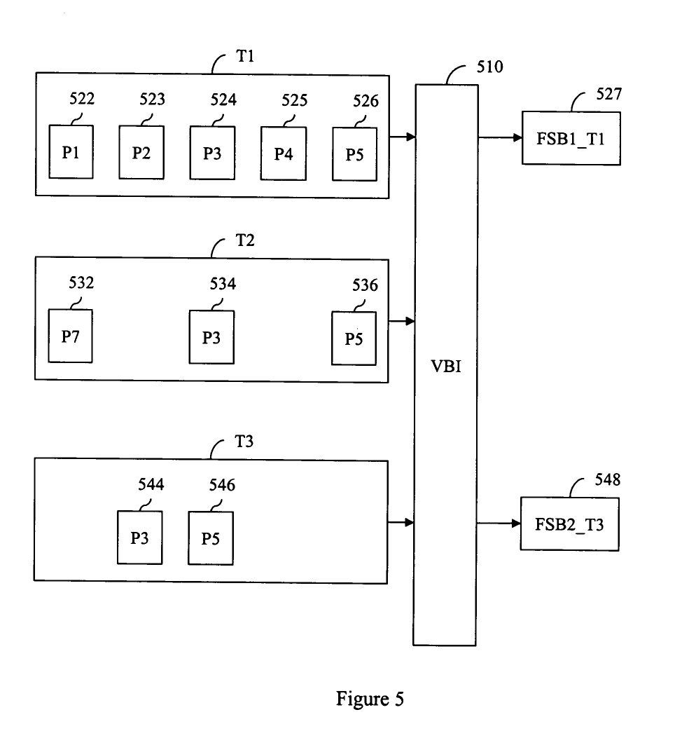

FIG. 5 illustrates an example message flow associated with a VBI 510 that is configured to selectively suppress the production of bus transactions from some P2P transactions. The VBI 510 may be configured to suppress, for example, non-translatable transactions like null transactions, irrelevant transactions like P2P internal transactions, and P2P transactions that a user specifies are not to be translated.

A first transaction T1, which includes a set of packets P1 522, P2 523, P3 524, P4 525, and P5 526 may be presented to the VBI 510. The nomenclature Px refers to a packet P with an identifier x that facilitates identifying a packet type. For example, a packet P1 may indicate that the packet is a header packet for a read transaction. Similarly, a packet P7 may indicate that the packet is a header packet for a P2P routing request. The set of packets in transaction T1 may describe a valid non-null, non-P2P internal transaction and thus may lead to the VBI 510 producing a first front-side bus transaction FSB1_T1. A second transaction T2, which includes a set of packets P7 532, P3 534, and P5 536 may similarly be presented to VBI 510. Transaction T2 may be a null transaction. In this example, transactions that begin with a packet P7 may be identifiable as null transactions. However, the VBI 510 may be configured to do more than just translate. Thus, rather than simply ignoring packet P7 532, the VBI 510 may take actions like marking the transaction T2 as a transaction to suppress, updating a data store or data structure to indicate that transaction T2 is a transaction to suppress and so on. After taking the action to facilitate identifying that packets P3 534 and P5 536 belong to transaction T2, which is to be suppressed, the VBI 510 may continue to process transaction T2 to completion by receiving and processing packets P3 534 and P5 536. Thus, rather than receiving packet P3 534 and having it appear to not belong to a current transaction, which could trigger processing of a new transaction, the VBI 510 will be able to correctly process transaction T2 and account for packets P3 534 and P5 536.

Tracking and processing to completion transactions for which a bus type transaction will not be produced facilitates avoiding a problem that could occur if, for example, transaction T2 was not correctly handled and packets P3 534 and P5 536 arrived. As can be seen by the VBI 510 processing transaction T3 into a related bus transaction FSB2_T3 548, the packets P3 544 and P5 546 form a valid, non-null, non-P2P internal transaction. If packet P7 532 were simply discarded, and if packets P3 534 and P5 536 subsequently arrived and were not handled as part of transaction T2, then an “extra” transaction could be produced by the VBI 510.

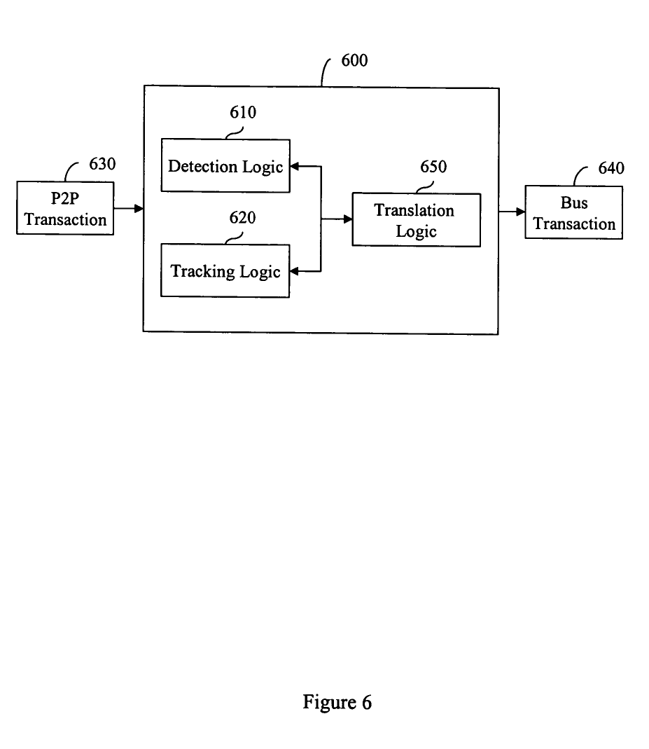

FIG. 6 illustrates components of an example system for selectively suppressing the production by a VBI 600 of bus-type transactions from some P2P transactions. The system may be configured to alter the behavior of the VBI 600, which is initially configured to produce bus-type transactions from P2P transactions. The system may include a detection logic 610 that is configured to determine whether a P2P transaction to be processed by the VBI 600 is a transaction for which no bus-type transaction is to be produced. For example, the detection logic 610 may be configured to detect null-type transactions, P2P internal transactions, user-specified transactions, and so on.

The system may also include a tracking logic 620 operably connected to the detection logic 610. The tracking logic 620 may be configured to track a P2P transaction 630 as it is processed by the VBI 600 and to suppress the generation of a bus-type transaction 640 by a translation logic 650 in the VBI 600. In one example, the detection logic 610 may be configured to detect that the P2P transaction 630 is a transaction for which no bus-type transaction 640 is to be produced by examining a packet identifier associated with a header packet in the P2P transaction 630 provided to the VBI 600. In another example, the tracking logic 620 may be configured to suppress the production of a bus-type transaction 640 by the translation logic 650 taking actions like, updating a value in a data structure and/or data store associated with tracking the P2P transaction 630, and marking P2P 630 transaction with a suppression tag.

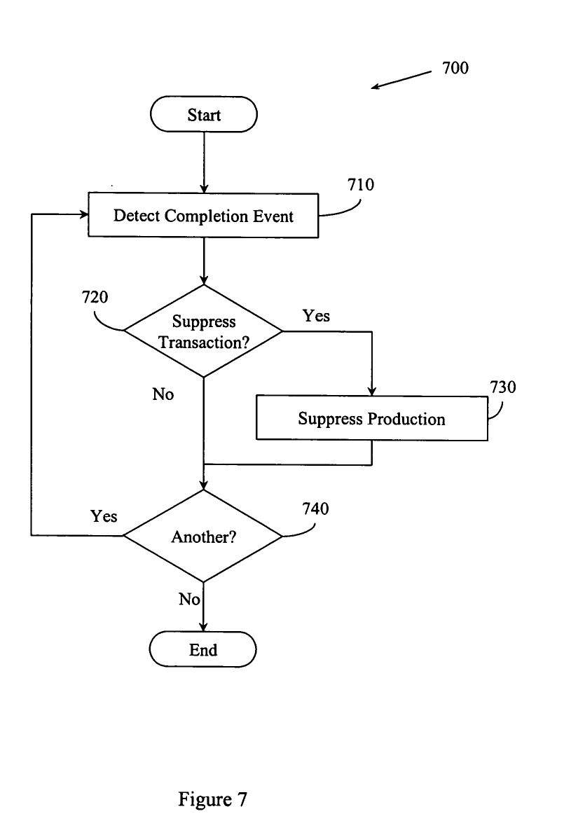

Example methods may be better appreciated with reference to the flow diagram of FIG. 7. While for purposes of simplicity of explanation, the illustrated methodology is shown and described as a series of blocks, it is to be appreciated that the methodology is not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks.

In the flow diagram, blocks denote “processing blocks” that may be implemented with logic. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that electronic and software applications may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques.

FIG. 7 illustrates an example method 700 for selectively suppressing the production of bus transactions from some P2P transactions. The method 700 may include, at 710, detecting a completion event associated with a P2P transaction being received in a VBI. Once a completion event has been detected at 710, the method 700 may make a determination at 720 concerning whether the received P2P transaction is a transaction for which no bus-type transaction is to be produced (e.g., is transaction to be suppressed). If the determination at 720 is Yes, then at 730 the method may include selectively suppressing the production of a bus-type transaction from the P2P transaction. The types of transactions that can be suppressed include, but are not limited to, null-type transactions, P2P internal transactions, and user-specified transactions.

To facilitate suppressing the production of a bus-type transaction from a P2P transaction, the method 700 may include taking actions like, manipulating a memory location to identify the P2P transaction to the VBI as a transaction for which no bus-type transaction is to be produced, and marking the P2P transaction to identify the P2P transaction to the VBI as a transaction for which no bus-type transaction is to be produced. Thus, as a transaction proceeds through a VBI, various logics in the VBI may be able to reference the manipulated memory location and/or the transaction marking to determine whether to produce a bus-type transaction for the P2P transaction.

While FIG. 7 illustrates various actions occurring in serial, it is to be appreciated that various actions illustrated in FIG. 7 could occur substantially in parallel. By way of illustration, a first process could detect completion events. Similarly, a second process could determine whether a transaction is a transaction type for which no bus-type transaction is to be produced, while a third process could facilitate suppressing bus-type transaction production by manipulating memory, marking transactions, and so on. While three processes are described, it is to be appreciated that a greater and/or lesser number of processes could be employed and that lightweight processes, regular processes, threads, and other approaches could be employed.

In one example, methodologies are implemented as processor executable instructions and/or operations stored on a computer-readable medium. Thus, in one example, a computer-readable medium may store processor executable instructions operable to perform a method that includes detecting a completion event associated with a P2P transaction being received in a VBI and determining whether the P2P transaction is one of, a null-type transaction, a P2P internal transaction, and a user-specified transaction for which no bus-type transaction is to be produced. Upon determining that the P2P transaction is a transaction for which no bus-type transaction is to be produced, the method may include performing actions including, but not limited to, manipulating a memory location to identify the P2P transaction to the VBI as a transaction for which no bus-type transaction is to be produced, and marking the P2P transaction to identify the P2P transaction to the VBI as a transaction for which no bus-type transaction is to be produced. Then, based on the marking and/or manipulated memory location, the method may include selectively suppressing the production of a bus-type transaction from the P2P transaction.

While the above method is described being stored on a computer-readable medium, it is to be appreciated that other example methods described herein can also be stored on a computer-readable medium.

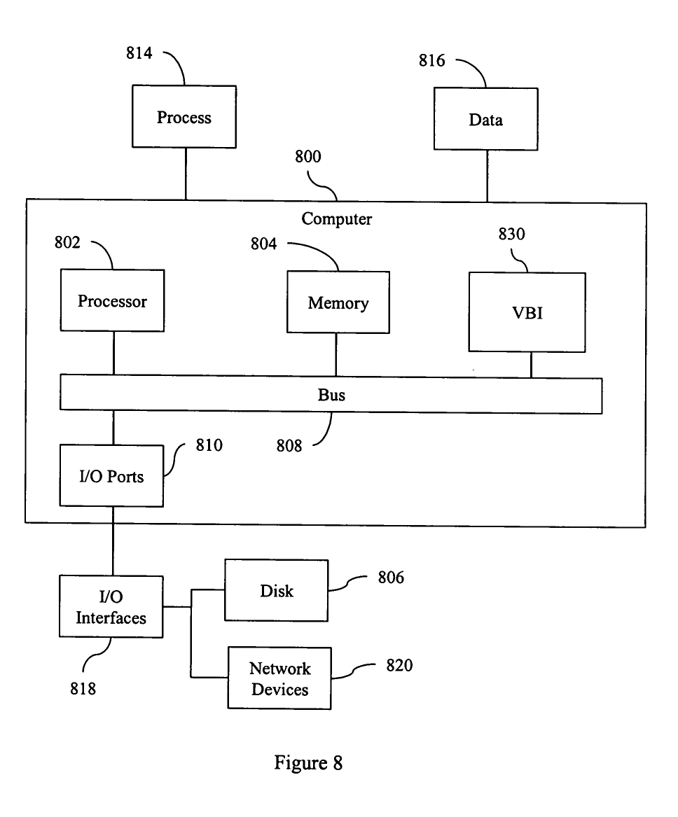

FIG. 8 illustrates a computer 800 that includes a processor 802, a memory 804, and input/output ports 810 operably connected by a bus 808. In one example, the computer 800 may include a VBI 830 configured to facilitate converting P2P transactions into bus-type transactions. The VBI 830 may be reconfigured according to the systems and methods described herein to facilitate selectively suppressing the production of bus-type transactions from some P2P type transactions (e.g., null-type, P2P internal type, user-specified).

The processor 802 can be a variety of various processors including dual microprocessor and other multi-processor architectures. The memory 804 can include volatile memory and/or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 806 may be operably connected to the computer 800 via, for example, an input/output interface (e.g., card, device) 818 and an input/output port 810. The disk 806 can include, but is not limited to, devices like a magnetic disk drive, a solid state disk drive, a floppy disk drive, a tape drive, a Zip drive, a flash memory card, and/or a memory stick. Furthermore, the disk 806 can include optical drives like a CD-ROM, a CD recordable drive (CD-R drive), a CD rewriteable drive (CD-RW drive), and/or a digital video ROM drive (DVD ROM). The memory 804 can store processes 814 and/or data 816, for example. The disk 806 and/or memory 804 can store an operating system that controls and allocates resources of the computer 800.

The bus 808 can be a single internal bus interconnect architecture and/or other bus or mesh architectures. While a single bus is illustrated, it is to be appreciated that computer 800 may communicate with various devices, logics, and peripherals using other busses that are not illustrated (e.g., PCIE, SATA, Infiniband, 1394, USB, Ethernet). The bus 808 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 800 may interact with input/output devices via i/o interfaces 818 and input/output ports 810. Input/output devices can include, but are not limited to, a keyboard, a microphone, a pointing and selection device, cameras, video cards, displays, disk 806, network devices 820, and the like. The input/output ports 810 can include but are not limited to, serial ports, parallel ports, and USB ports.

The computer 800 can operate in a network environment and thus may be connected to network devices 820 via the i/o devices 818, and/or the i/o ports 810. Through the network devices 820, the computer 800 may interact with a network. Through the network, the computer 800 may be logically connected to remote computers. The networks with which the computer 800 may interact include, but are not limited to, a local area network (LAN), a wide area network (WAN), and other networks. The network devices 820 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, the network devices 820 can connect to WAN technologies including, but not limited to, point to point links, circuit switching networks like integrated services digital networks (ISDN), packet switching networks, and digital subscriber lines (DSL).

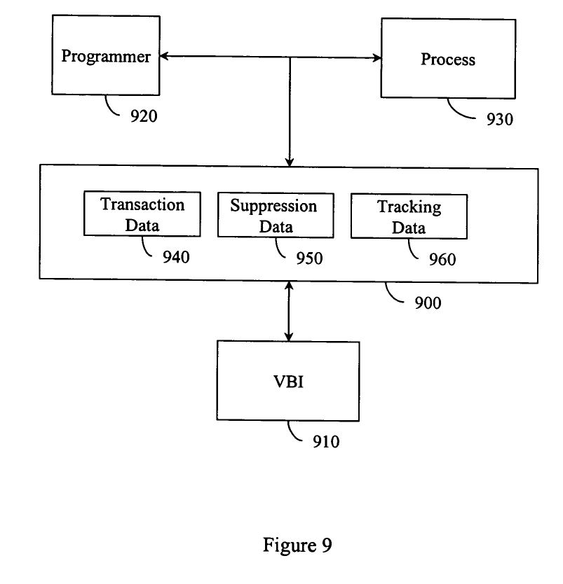

Referring now to FIG. 9, an application programming interface (API) 900 is illustrated providing access to a VBI 910. The API 900 can be employed, for example, by a programmer 920 and/or a process 930 to gain access to processing performed by the VBI 910. For example, a programmer 920 can write a program to access the VBI 910 (e.g., invoke its operation, monitor its operation, control its operation) where writing the program is facilitated by the presence of the API 900. Rather than programmer 920 having to understand the internals of the VBI 910, the programmer 920 merely has to learn the interface to the VBI 910. This facilitates encapsulating the functionality of the VBI 910 while exposing that functionality.

Similarly, the API 900 can be employed to provide data values to the VBI 910 and/or retrieve data values from the VBI 910. For example, a process 930 that compares bus-type transactions and P2P transactions can provide a transaction to the system 910 via the API 900 by, for example, using a call provided in the API 900. Thus, in one example of the API 900, a set of application programming interfaces can be stored on a computer-readable medium. The interfaces can be employed by a programmer, computer component, logic, and so on to gain access to VBI 910. The interfaces can include, but are not limited to, a first interface 940 that communicates a transaction data (e.g., a transaction, a set of packets, a set of flits), a second interface 950 that communicates a translation suppression data (e.g., marking, flag, semaphore), and a third interface 960 that communicates a tracking data that facilitates suppressing the production of a bus-type transaction from a P2P transaction based, at least in part, on the suppression data.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

1. A system configured to alter the behavior of a virtual bus interface that produces bus-type transactions from point-to-point transactions, the system comprising:
a detection logic configured to detect that a point-to-point transaction to be processed by the virtual bus interface is a transaction for which no bus-type transaction is to be produced; and
a tracking logic operably connected to the detection logic, the tracking logic being configured to track the point-to-point transaction as it is processed by the virtual bus interface and to selectively suppress the generation of a bus-type transaction by a translation logic in the virtual bus interface.

2. The system of claim 1, where the detection logic is configured to detect that a point-to-point transaction is a transaction for which no bus-type transaction is to be produced by examining a packet identifier in a header packet associated with the point-to-point transaction.

3. The system of claim 1, where the tracking logic is configured to suppress the generation of a bus-type transaction by the translation logic in the virtual bus interface by updating a value in a data structure associated with tracking the point-to-point transaction, where the value is referenced by the translation logic before providing a bus-type transaction.

4. The system of claim 1, where the tracking logic is configured to suppress the generation of a bus-type transaction by the translation logic in the virtual bus interface by updating a value in a data store associated with tracking the point-to-point transaction, where the value is referenced by the translation logic before providing a bus-type transaction.

5. The system of claim 1, where the tracking logic is configured to suppress the generation of a bus-type transaction by the translation logic in the virtual bus interface by marking the point-to-point transaction with a suppression tag, where the tag is referenced by the translation logic before providing a bus-type transaction.

6. The system of claim 1, where the point-to-point transaction comprises a null-type transaction.

7. The system of claim 1, where the point-to-point transaction comprises a point-to-point internal transaction.

8. The system of claim 1, where the detection logic is further configured to receive an input from a user, where the input identifies a point-to-point transaction type to be suppressed.

9. A virtual bus interface system configured to selectively produce a bus-type transaction from a point-to-point type transaction, comprising:
a point-to-point transaction logic configured to receive a packet associated with a point-to-point transaction from a point-to-point linked system;
a detection logic configured to determine whether the packet identifies the point-to-point transaction as a transaction for which no bus-type transaction is to be produced;
a bus-type transaction logic configured to selectively produce a bus-type transaction from a point-to-point transaction received by the point-to-point transaction logic;
a tracking logic configured to track a point-to-point transaction as it processed into a bus-type transaction by the bus-type transaction logic; and
a suppression logic configured to control the bus-type transaction logic to selectively produce a bus-type transaction from the point-to-point transaction, based, at least in part, on the determination made by the detection logic.

10. The system of claim 9, where upon detecting that a point-to-point transaction is a transaction for which no bus-type transaction is to be produced, the detection logic stores a value in a data structure associated with the virtual bus interface system, where the value uniquely identifies the transaction, and where the suppression logic controls the bus-type transaction logic based, at least in part, on the value.

11. The system of claim 9, where upon detecting that a point-to-point transaction is a transaction for which no bus-type transaction is to be produced, the detection logic stores a value in a data store associated with the virtual bus interface system, where the value uniquely identifies the transaction, and where the suppression logic controls the bus-type transaction logic based, at least in part, on the value.

12. The system of claim 9, where upon detecting that a point-to-point transaction is a transaction for which no bus-type transaction is to be produced, the detection logic marks the transaction as a transaction for which no bus-type transaction is to be produced, and where the suppression logic controls the bus-type transaction logic based on the marking.

13. The system of claim 9, where the detection logic is configured to detect one or more of, a null-type transaction, a point-to-point internal transaction, and a user-specified transaction.

14. A method, comprising:
detecting a completion event associated with a point-to-point transaction being received in a virtual bus interface;
determining whether the point-to-point transaction is a transaction for which no bus-type transaction is to be produced; and
selectively suppressing production by the virtual bus interface of a bus-type transaction from the point-to-point transaction.

15. The method of claim 14, including manipulating a memory location to identify the point-to-point transaction to the virtual bus interface as a transaction for which no bus-type transaction is to be produced.

16. The method of claim 14, including marking the point-to-point transaction to identify the point-to-point transaction to the virtual bus interface as a transaction for which no bus-type transaction is to be produced.

17. The method of claim 14, including selectively suppressing the production of a bus-type transaction from the point-to-point transaction when the point-to-point transaction comprises one or more of, a null-type transaction, a point-to-point internal transaction, and a user-specified transaction.

18. A computer-readable medium storing processor executable instructions operable to perform a method, the method comprising:
detecting a completion event associated with a point-to-point transaction being received in a virtual bus interface;
determining whether the point-to-point transaction is one of, a null-type transaction, a point-to-point internal transaction, and a user-specified transaction for which no bus-type transaction is to be produced;
upon determining that the point-to-point transaction is a transaction for which no bus-type transaction is to be produced, performing one or more of, manipulating a memory location to identify the point-to-point transaction to the virtual bus interface as a transaction for which no bus-type transaction is to be produced, and marking the point-to-point transaction to identify the point-to-point transaction to the virtual bus interface as a transaction for which no bus-type transaction is to be produced; and
selectively suppressing production by the virtual bus interface of a bus-type transaction from the point-to-point transaction based on one or more of, the marking and the manipulated memory location.

19. A system, comprising:
means for determining whether a packet associated with a point-to-point transaction received by a virtual bus interface identifies the point-to-point transaction as a transaction type for which no bus transaction is to be produced by the virtual bus interface;
means for identifying a packet and a point-to-point transaction for which no bus transaction is to produced to the virtual bus interface to facilitate processing a subsequently received packet associated with the point-to-point transaction for which no bus transaction is to be produced by the virtual bus interface; and
means for suppressing the generation of a bus transaction from a point-to-point transaction based, at least in part, on the identification of the point-to-point transaction for which no bus transaction is to be produced by the virtual bus interface.

20. A set of application programming interfaces embodied on a computer-readable medium for execution by a computer component in conjunction with suppressing the generation of a bus model transaction from a point-to-point link transaction presented to a virtual bus interface, comprising:
a first interface for communicating a point-to-point transaction;
a second interface for communicating a suppression data configured to facilitate suppressing the generation of a bus model transaction from the point-to-point transaction; and
a third interface for communicating a suppressed transaction tracking data, where the suppressed transaction tracking data facilitates processing packets logically related to the point-to-point transaction for which the generation of a bus model transaction is to be suppressed.
